(19) United States
(12) Patent Application Publication
(10) Pub. No.: US 2024/0401687 A1
(43) Pub. Date: Dec. 5, 2024

(54) Belt Pulley Assembly

(71) Applicant: Belt Technologies, Inc., Agawam, MA (US)

(72) Inventors: Richard Lunden, Holland, MA (US); Alan Wosky, East Longmeadow, MA (US); Denis Gagnon, Longmeadow, MA (US)

(73) Assignee: Belt Technologies, Inc., Agawam, MA (US)

(21) Appl. No.: 18/429,406

(22) Filed: Jan. 31, 2024

Related U.S. Application Data
(60) Provisional application No. 63/442,340, filed on Jan. 31, 2023.

(51) Int. Cl. F16H 55/36

(52) U.S. Cl. CPC F16H 55/36; F16H 2055/366

(57) ABSTRACT

A belt pulley assembly mounted about a shaft to rotate a belt includes first and second segmented guides disks that each include a plurality of segments. To allow for lateral movement of the segments for improved tracking of the belt, guideposts include a plurality of springs positioned along an associated one of the guideposts to apply a correcting/restorative axial force to its associated segment to return the segment to its nominal axial position. Each of the springs is coaxially arranged with its associated guidepost.

### CROSS REFERENCE TO RELATED APPLICATIONS

This application claims the benefit of U.S. Provisional Patent Application Ser. No. 63/442,340 filed Jan. 31, 2023, which is hereby incorporated by reference.

### BACKGROUND OF THE INVENTION

### 1. Technical Field

This disclosure relates generally to a pulley assemblies, and, more particularly, to belt pulley assemblies with self-centering tracking.

### 2. Background Information

Given that a metal belt will not significantly stretch under tension, tracking a metal belt can be more difficult than tracking other belt types. A metal belt will not stretch to compensate for lack of system squareness or alignment, uncontrolled pulley shaft deflection, differential loading, or belt camber.

Among these, a skilled person is probably least familiar with belt camber. Camber, or edge bow, is the deviation of a belt edge from a straight line. Every belt has some camber. Metal belt camber is typically less than 0.05 inches (1.27 mm) in 8 feet (2.44 m). When placed in a squared two-pulley system and tensioned, one edge of the belt will be tensioned more than the other because it has a shorter edge circumference. This will cause the belt to track away from the tight edge of tension towards the loose edge when the belt is rotated.

A primary objective of any tracking technique is to counteract the influence of accumulative negative tracking stresses and forces (e.g., system squareness, uncontrolled shaft deflection, differential loading and belt camber) with controlled stresses and forces, thus tuning the belt to run on the system.

Techniques often used to track belts on systems using friction pulleys, timing pulleys or both, include pulley axis adjustment, crowning friction drive pulley, and forced tracking.

Adjusting the pulley axis in a metal belt system is an effective way of tracking a metal belt. Belt edge tensions are changed in a controlled manner, thus steering the belt. The technique is equally applicable to both flat-faced and crowned pulleys.

Ideally, both the drive and idler pulleys would have adjustable axes. In reality, however, generally only the idler is adjusted. The drive pulley is usually difficult to adjust due to its interface with motors or other power transmission devices.

When crowned friction drive pulleys must be used, it is in conjunction with-not in place of-axis adjustment. This is because crowned pulleys will not self-center a metal belt. Crowned pulleys work best on thin belts as the belt web must conform to the crowned face of the pulley. While increased tension can be used to achieve belt to pulley face conformity, the tension cannot be so high as to cause permanent belt deformation. The best face geometry for a crowned pulley is a full radius with the crowning being no more than the belt thickness.

In cases where simple axis adjustment cannot completely eliminate improper tracking, forced tracking methods such as cam followers or flanges may be necessary. System design relationships may need to change, such as using a thicker belt than might be otherwise recommended, since forced tracking techniques can add high forces to the belt edge, which can contribute to a decrease in expected belt life.

An alternative forced tracking technique for wider belts employs a V belt bonded to the inner circumference of the metal belt. This two-element belt, referred to as a METRAK® belt sold by Belt Technologies, the assignee of present invention, distributes tracking stresses on the V belt rather than on the metal belt to increase belt life.

U.S. Pat. No. 5,676,613 assigned to the assignee of the present application, discloses an independently steerable tube stock idler pulley. U.S. Pat. No. 5,129,865 also assigned to the assignee of the present application discloses a spherical tooth pulley that engages a belt having a series of spaced openings therein. U.S. Pat. No. 3,719,098 discloses a belt pulley assembly including spaced pulleys each constructed as a set of slotted discs, which are flexible in response to transverse forces imparted between the belt and pulley.

There is a need for a belt pulley assembly with improved belt tracking.

### SUMMARY OF THE DISCLOSURE

According to an aspect of the disclosure, a belt pulley assembly mounted about a shaft to rotate a belt includes a central hub having a central hub recess configured to receive the shaft, and having a first radial central hub face and an opposing second radial central hub face, where each of the first and second radial central hub faces includes a plurality of central hub axial through holes. A first segmented guide disk rotates about the shaft and includes first and second opposing radial sidewalls each including a plurality of axially extending first disk holes. A second segmented guide disk that rotates about the shaft coaxial with the first segmented guide disk, and comprising third and fourth opposing radial sidewalls each including a plurality of axially extending second disk holes. A first end plate section includes a first inner cap co-axially adjacent to the first segmented guide disk and comprising a first end plate section face that includes a plurality of first inner cap channels. A second end plate section includes a second inner cap co-axially adjacent to the second segmented guide disk and comprising a second end plate section face that includes a plurality of second inner cap channels. A first plurality of springs coaxially extend between an associated one of the first inner cap channels and an associated one of the plurality of axially extending first disk holes extending through the first opposing radial sidewall. A second plurality of springs coaxially extend between an associated one of the plurality of axially extending first disk holes extending through the second opposing radial sidewall and an associated one of the plurality of the central hub axial bores extending through the first radial central hub face. A third plurality of springs extend between an associated one of the plurality of the central hub axial bores extending through the second radial central hub face and an associated one of the plurality of axially extending second disk holes extending through the third opposing radial sidewall. A fourth plurality of springs extend between an associated one of the plurality of axially extending second disk holes extending through the fourth opposing radial sidewall and an associated one of the plurality of plurality of second inner cap channels.

At least one of the first, second, third and fourth springs may include a helical spring.

The belt pulley assembly may be a belt drive pulley assembly.

The belt pulley assembly may be a belt idler pulley assembly.

The first end plate section may include a first outer cap axially exterior to the first inner cap, and where the second end plate section includes a second outer cap axially exterior to the second inner cap.

The belt assembly may include a cam follower attached to the first end plate section axially exterior to the first inner cap to contact the belt when the belt is not tracking in its nominal tracking position over the first segmented guide disk.

The central hub may be cylindrical and has a central hub radius, the first segmented guide disk may be cylindrical and has a first disk radius, and the second segmented guide disk may be cylindrical and has a second disk radius, where the first and second disk radiuses may equal and may be greater than the central hub radius.

The first and second end plates may be snap fit to the shaft.

The belt pulley assembly may include a plurality of axially extending guideposts that extend into (i) an associated one of the plurality of first inner cap channels, and (ii) associated ones of the axially extending first and second disk holes.

Each of the plurality of guideposts coaxial and radially interior with respect to the first plurality of springs may have an axial proximate end in an associated one of the plurality of first inner cap channels and axially secured to the first inner cap with a threaded fastener.
The plurality of axially extending guideposts have a cylindrical cross section.

According to another aspect of the disclosure, a belt pulley assembly mounted about a shaft to rotate a belt, the belt pulley assembly includes a segmented guide disk that rotates about the shaft and includes first and second opposing radial sidewalls and a plurality of axially extending disk holes that includes a linear bearing and extend between the first and second opposing radial sidewalls. A first end plate section that includes a first inner cap is co-axially adjacent to the segmented guide disk and includes a first end plate section face that includes a plurality of first inner cap channels. A second end plate section that includes a second inner cap is co-axially adjacent to the segmented guide disk and includes a second end plate section face that includes a plurality of second inner cap channels, where the segmented guide disk axially separates the first and second end plate sections. A first plurality of springs extend between an associated one of the first inner cap channels and an associated one of the plurality of axially extending disk holes extending into the first opposing radial sidewall. A second plurality springs extend between an associated one of the plurality of axially extending disk holes extending into the second opposing radial sidewall and an associated one of the plurality of second inner cap channels. A plurality of axially extending guideposts each extend into an associated one of the axially extending disk holes and the axial ends of each of the guideposts extend into an associated one of the first and second inner cap channels. A plurality of linear bearings are located about the guideposts within each of the plurality of axially extending disk holes.

The radius of the segmented disk guide may be greater than the radius of the first and second end plate sections.

The first end plate section may include a first outer cap axially exterior to the first inner cap, where the second end plate section may include a second outer cap axially exterior to the second inner cap.

The belt assembly may include a cam follower attached to radial periphery of the first end plate section axially exterior to the first inner cap to contact the belt when the belt is not tracking in its nominal tracking position over the first segmented guide disk.

The first segmented guide disk may be cylindrical and have a disk radius, and the first and second inner caps may be cylindrical and have an inner cap radius, where the disk radius may be greater than the inner cap radius.

The foregoing features and the operation of the invention will become more apparent in light of the following description and the accompanying drawings.

### BRIEF DESCRIPTION OF THE DRAWINGS

FIG. 1 illustrates a perspective view of a belt pulley assembly;

FIG. 2 illustrates a simplified side view of the belt pulley assembly of FIG. 1;

FIG. 3 illustrates a simplified exploded perspective view of the belt pulley assembly of FIG. 1;

FIG. 4 illustrates a simplified exploded side view of the belt pulley assembly of FIG. 1;

FIG. 5A illustrates a side view of a segment of a segmented guide disk used in the belt pulley assembly of FIGS. 1-4;

FIG. 5B illustrates a front view of the segment of the segmented guide disk illustrated in FIG. 5A;

FIG. 6 illustrates an embodiment of a shaft;

FIG. 7 illustrates a perspective view of an alternative embodiment belt pulley assembly;

FIG. 8 illustrates a simplified exploded perspective view of the alternative embodiment belt pulley assembly of FIG. 7; and

FIG. 9 illustrates a simplified exploded side view of the alternative embodiment belt pulley assembly of FIGS. 7-8.

### DETAILED DESCRIPTION

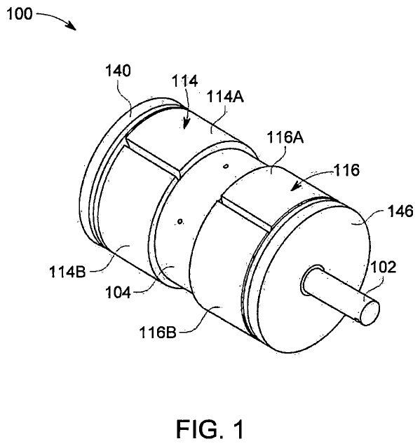

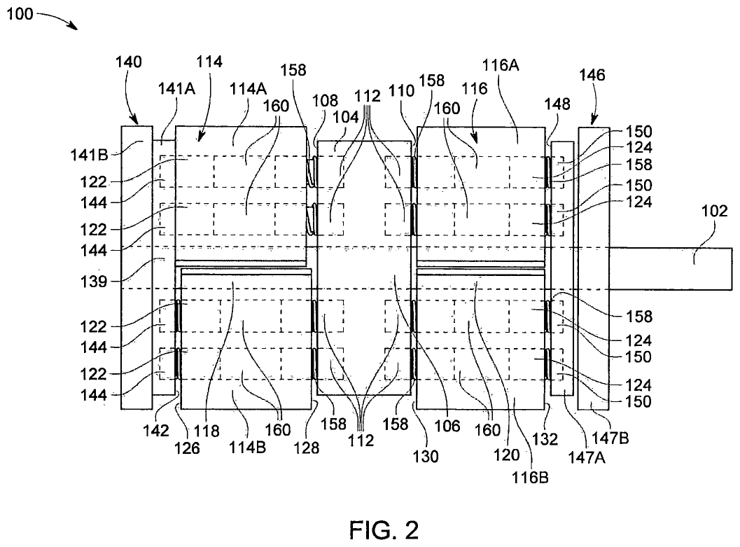

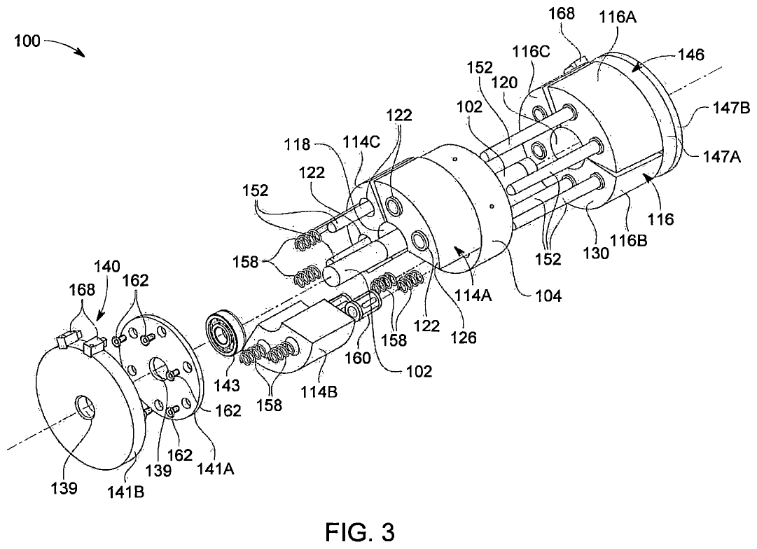

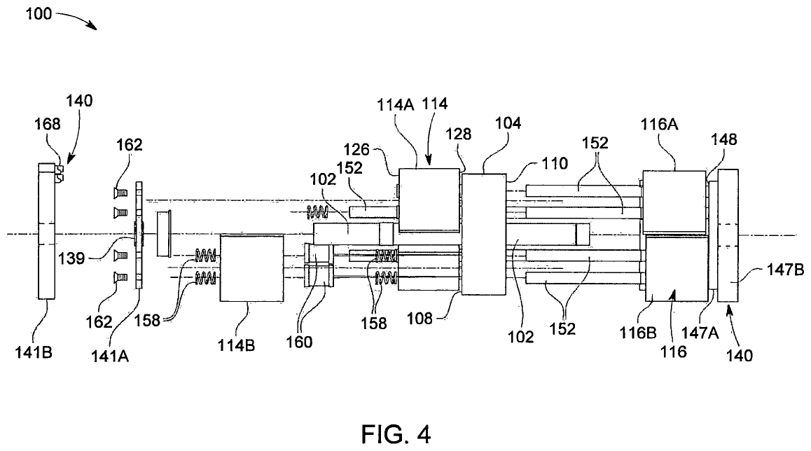

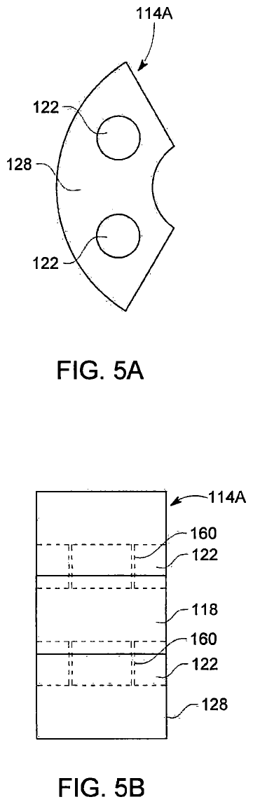

FIG. 1 illustrates a perspective view of a belt pulley assembly 100. The belt pulley assembly 100 is mounted to a rotary shaft 102 to rotate a belt (not shown). The shaft may be a drive shaft where the belt pulley assembly is part of a drive assembly. The belt pulley assembly may also be part of an idler pulley assembly. In an exemplary embodiment the belt is a metal belt, but it is contemplated that the belt may be semi-metallic or non-metallic. FIG. 2 illustrates a simplified side view of the belt pulley assembly of FIG. 1. FIG. 3 illustrates a simplified exploded perspective view of the belt pully assembly of FIG. 1. FIG. 4 illustrates a simplified exploded side view of the belt pulley assembly of FIG. 1. FIG. 5A illustrates a side view of one segment 114A. FIG. 5B illustrates a front view of the segment 114A illustrated in FIG. 5A.

Referring to FIGS. 1-5B, the belt pulley assembly 100 includes a cylindrical central hub 104 having a central hub recess 106 therein, which receives the shaft 102. The central hub 104 also includes a first radial face 108 and an opposing second radial face 110, where each of the first and second radial faces 108, 110 include a plurality of central hub axial bores 112. The central hub recess 106 extends between the first and second radial faces 108, 110. The central hub axial bores 112 may be blind holes.

The belt pulley assembly 100 also includes a first segmented guide disk 114 and a second segmented guide disk 116, which are separated and axially adjacent to the cylindrical central hub 104. The first and second segmented guide disks 114, 116 each include a disk axial shaft opening 118, 120 respectively, that receive the rotary shaft 102. The first segmented guide disk 114 includes a plurality of axially extending first disk holes 122, and the second segmented guide disk 116 includes a plurality of axially extending second disk holes 124.

The first segmented guide disk 114 includes first and second opposing radial sidewalls 126, 128. The axially extending first disk holes 122 extend between the first and second opposing radial sidewalls 126, 128.

The second segmented guide disk 116 includes first and second opposing radial sidewalls 130, 132. The axially extending second disk holes 124 extend between the first and second opposing radial sidewalls 130, 132. Each of the plurality of axially extending first disk holes 122 is coaxial with an associated one of the plurality of axially extending second disk holes 124 and an associated one of the central hub axial bores 112.

Each of the first and second segmented guide disks 114, 116 includes a plurality of radial segments. For example, in an exemplary embodiment as shown in FIGS. 1-4, each of the first and second segmented guide disks 114, 116 comprise three (3) circumferentially separated segments 114A, 114B, 114C and 116A, 116B, 116C (see the circumferentially separated segments 114A, 114B, 114C and 116A, 116B, 116C in FIG. 3). However, it is contemplated that the belt pulley assembly 100 may include segmented guide disks that each include two or more radially separated segments. For example, in a guide disk that includes two radially separated segments the disk segments can be substantially semi-circular. In an exemplary embodiment shown herein, each of the segments 114A, 114B and 114C is circumferentially separated from each other. Similarly, each of the segments 116A, 116B and 116C is circumferentially separated from each other. In this exemplary embodiment, each segment segments 114A, 114B and 114C of the first disk 114 may span 115 degrees, which provides 5 degrees of circumferential separation between circumferentially adjacent segments in the first disk 114. The segments in the second disk 116 may be similar.

The diameter of the cylindrical central hub 104 is slightly less than the first and second radially segmented guide disks 114, 116 so the belt (not shown) contacts the disks 114, 116 but not the central hub. The central hub 104 is axially stationary with respected to the drive shaft, while the disks may move axially within a limited range.

Referring still to FIGS. 1-5B, the belt pulley assembly 100 also includes a first end plate/cap section 140 co-axially adjacent to the first segmented guide disk 114. The first end plate/cap section 140 includes a first inner cap 141A and a first outer cap 141B. The first inner cap 141A of the first end plate section 140 includes a first face 142 having a plurality of first inner cap channels/blind holes 144, which are each coaxial with an associated one of the plurality of axially extending first disk holes 122. The outer cape 141B also includes a through hole 139 that is sized to accepts a bearing 143 that receives the shaft 102. The first inner cap 141A rotates with the shaft, while the outer cap 141B does not rotate. In addition, a second end plate/cap section 146 is co-axially adjacent to the second segmented guide disk 116. The second end plate section 146 includes a second inner cap 147A and a second outer cap 147B. The second inner cap 147A includes a second face 148 having a plurality of second inner cap channels 150, which are each coaxial with an associated one of the plurality of axially extending second disk holes 124. In an exemplary embodiment the channels 144, 150 are not through holes extending through their associated inner cap 141A, 147A. Each channel 144, 150 may partially extend through its associated inner cap 141A, 147A to receive an axial end of a guide rod to be discussed hereinbelow.

In this exemplary embodiment, the first and second segmented guide disks 114, 116 each comprise three (3) circumferentially separated segments. In other embodiments, it is contemplated that the guide disks may include more or less separate segments.

Referring still to FIGS. 1-5B, the belt pulley assembly 100 also includes a plurality of axially extending guideposts 152 that pass through (i) an associated one of the plurality of hub axial bores 112, (ii) associated ones of the axially extending first and second disk holes 122, 124, and the axial ends of each guidepost extend into an associated one of the first and second end plate channels 144, 150.

To allow the segments 114A, 114B, 114C and 116A, 116B, 116C to move laterally (i.e., axially) between its adjacent end plate/cap sections 140, 146 and the cylindrical central hub 104, a plurality of compressions springs 158 are mounted along each of the guideposts. The springs shall be discussed hereinbelow.

Given the segmented structure of the disks 114, 116, each disk may include two (2) bores to receive an associated one of the guideposts. However, it is contemplated that one or more than two guideposts can be used per segment. As shown in FIG. 5B, each of the segments 114A, 114B, 114C and 116A, 116B, 116C includes a linear/sleeve bearing 160 within the axial extending first and second disk holes 122, 124 that receive the guideposts. The linear/sleeve bearings 160 allow for slight lateral/axial movement of the segment.

To provide lateral movement of the segments 114A, 114B, 114C and 116A, 116B, 116C for improved tracking of the belt (not shown), each of the guideposts 152 includes an associated one of a plurality of springs 158. In an exemplary embodiment shown herein, each guidepost may include two springs that apply a correcting/restorative axial force to its associated segment to return the segment to its nominal axial position. Each of the springs 158 is coaxially arranged with its associated guidepost.

For each guidepost 152, on a first axial side of the central hub 104 a first spring may be radially positioned about the associated guidepost and between a lateral wall of the first disk hole 122 and a first axial side of the linear/sleeve bearing 160 in the associated first disk hole 122. A second spring, also positioned radially about the guidepost, is positioned laterally/axially between a second axial aside of the linear/sleeve bearing 160 and a key extending from the cylindrical walls that form the central hub recess 106. A third spring is radially positioned about the guidepost and axially between the key extending from the cylindrical walls that form the central hub recess 106 and a first axial side of the linear/sleeve bearing in the axially extending second disk hole 124. A fourth spring is radially positioned about the guidepost and axially between a lateral wall of the second end plate channel 150 and a second axial side of the linear/sleeve bearing 160 in the axially extending second disk hole 124. Each of the other guideposts may include a similar arrangement of springs. It is contemplated that only one guidepost with springs may be required for each radially segmented guide disk. Similarly, more than two guideposts may be used per segment.

The springs 158 and the linear bearings 160 allow each segment to move axially in response to an applied force and when the applied force is reduced/removed the springs cause the segment to return to its nominal axial position.

To further increase tracking accuracy, cam followers 168 are positioned on the outer caps 141B, 147B to contact the rotating metal belt when the belt is not tracking correctly.

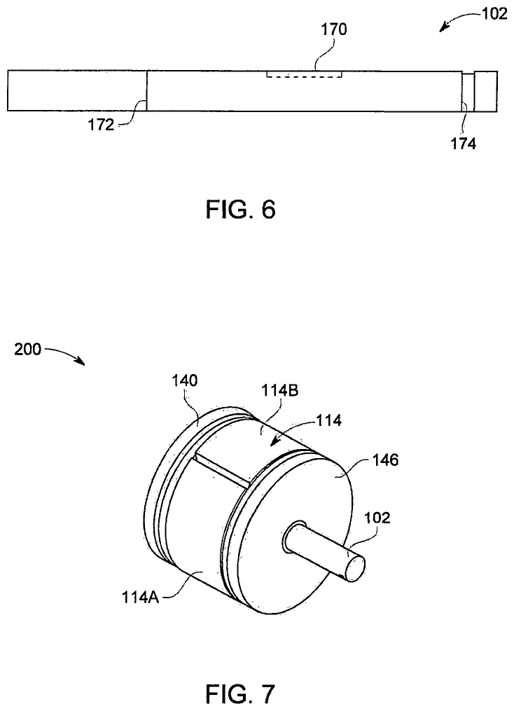

FIG. 6 illustrates an exemplary embodiment of the rotary shaft 102. In this embodiment the cylindrical shaft includes an axially extending keyway 170 that receives a key extending from the cylindrical walls that form the central hub recess 106. The rotary shaft 102 may also include first and second snap ring grooves 172, 174 that facilitate a snap fit of the inner caps 141A, 147A (FIG. 3) to the shaft 102. While the shaft is preferably round, it is contemplated that other cross-sectionally shaped shafts may be used.

Each of the plurality of guideposts axially adjacent to an associated one of the first inner cap 141A or second inner cap 147 may be axially secured to is associated inner cap with a threaded fastener 162.

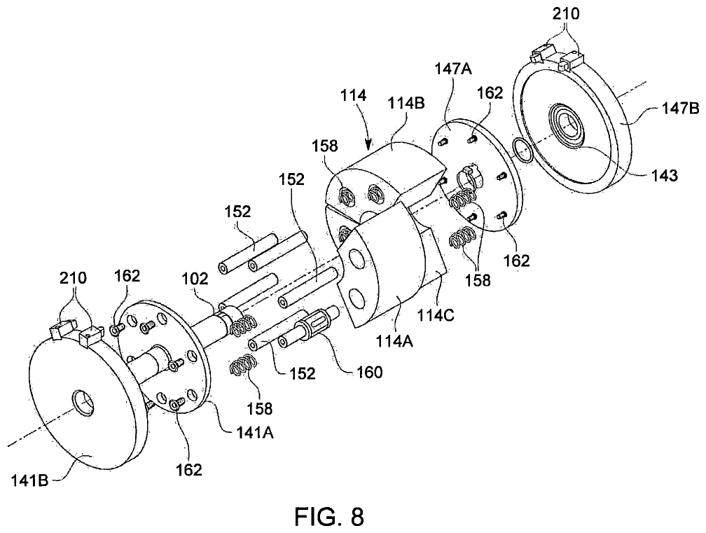

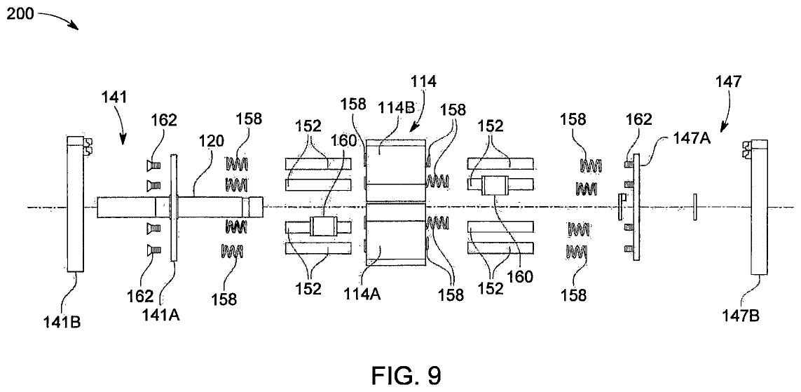

FIG. 7 illustrates a perspective view of an alternative embodiment belt pulley assembly 200. FIG. 8 illustrates a simplified exploded perspective view of the alternative embodiment belt pulley assembly 200 of FIG. 7. FIG. 9 illustrates a simplified exploded side view of the alternative embodiment belt pulley assembly of FIGS. 7-8. Referring to FIGS. 1-9, the pulley assembly 200 is substantially the same as the embodiment in FIGS. 1-6, but primary differences are that the alternative embodiment does not include the central hub 104 (FIG. 1) and the second segmented guide disk 116 shown in FIG. 1. In the embodiment illustrated in FIGS. 7-9, the springs on each axial side of the first disk 114 abut against an adjacent one of the inner caps 141A, 147B. The shaft may include a plurality of keyways to rotationally connect the segment disk 114 and the inner caps 141A, 147A to the shaft 102.

The radius of the segmented disk guide 114 may be greater than the radius of the inner caps 141A, 147A.

Since the inner caps 141A, 147A rotate with the segmented guide disk 114, cam followers 210 may be mounted to the outer caps 141B, 147B or axially exterior to the outer caps 141A, 147A

While the exemplary embodiments set forth above use springs to actuate an unloaded segment back to its nominal axial position, it is contemplated that permanent magnets may be used rather than springs. Magnets would be inserted into counter bores on opposing faces of the inner caps 141A, 147A and guide disks, and on the opposing faces of the guide disks and the cylindrical central hub. The magnets would provide the restorative force to move a segment not in contact with the belt back to its nominal axial position.

In addition, while the embodiment in FIGS. 1-5 each of the first disk holes 122 and the second disk holes 124 may be through holes such that a guide rod extends through the associated segment, reducing the number of guide rods and linear bearings.

While various embodiments have been disclosed, it will be apparent to those of ordinary skill in the art that many more embodiments and implementations are possible. For example, as described herein includes several aspects and embodiments each include particular features. Although these features may be described individually, it is within the scope of this disclosure that some or all of these features may be combined with any one of the aspects and remain within the spirit and scope of the invention. Accordingly, the present invention is not to be restricted except in light of the attached claims and their equivalents.

What is claimed is:

1. A belt pulley assembly mounted about a shaft to rotate a belt, the belt pulley assembly comprising:
a central hub having a central hub recess configured to receive the shaft, and having a first radial central hub face and an opposing second radial central hub face, where each of the first and second radial central hub faces includes a plurality of central hub axial through holes;
a first segmented guide disk that rotates about the shaft and comprises first and second opposing radial sidewalls each including a plurality of axially extending first disk holes;
a second segmented guide disk that rotates about the shaft coaxial with the first segmented guide disk, and comprising third and fourth opposing radial sidewalls each including a plurality of axially extending second disk holes;
a first end plate section that includes a first inner cap co-axially adjacent to the first segmented guide disk and comprising a first end plate section face that includes a plurality of first inner cap channels;
a second end plate section that includes a second inner cap co-axially adjacent to the second segmented guide disk and comprising a second end plate section face that includes a plurality of second inner cap channels;
a first plurality of springs coaxially extending between an associated one of the first inner cap channels and an associated one of the plurality of axially extending first disk holes extending through the first opposing radial sidewall;
a second plurality of springs coaxially extending between an associated one of the plurality of axially extending first disk holes extending through the second opposing radial sidewall and an associated one of the plurality of the central hub axial bores extending through the first radial central hub face;
a third plurality of springs extending between an associated one of the plurality of the central hub axial bores extending through the second radial central hub face and an associated one of the plurality of axially extending second disk holes extending through the third opposing radial sidewall; and
a fourth plurality of springs extending between an associated one of the plurality of axially extending second disk holes extending through the fourth opposing radial sidewall and an associated one of the plurality of plurality of second inner cap channels.

2. The belt pulley assembly of claim 1, where at least one of the first, second, third and fourth springs comprises a helical spring.

3. The belt pulley assembly of claim 1, where the belt pulley assembly is a belt drive pulley assembly.

4. The belt pulley assembly of claim 1, where the belt pulley assembly is a belt idler pulley assembly.

5. The belt pulley assembly of claim 2, where the first end plate section comprises a first outer cap axially exterior to the first inner cap, and where the second end plate section comprises a second outer cap axially exterior to the second inner cap.

6. The belt assembly of claim 5, further comprising a cam follower attached to the first end plate section axially exterior to the first inner cap to contact the belt when the belt is not tracking in its nominal tracking position over the first segmented guide disk.

7. The belt pulley assembly of claim 1, where the central hub is cylindrical and has a central hub radius, the first segmented guide disk is cylindrical and has a first disk radius, and the second segmented guide disk is cylindrical and has a second disk radius, where the first and second disk radiuses are equal and are greater than the central hub radius.

8. The belt pulley assembly of claim 7, where the first and second end plates are snap fit to the shaft.

9. The belt pulley assembly of claim 7, further comprising a plurality of axially extending guideposts that extend into (i) an associated one of the plurality of first inner cap channels, and (ii) associated ones of the axially extending first and second disk holes.

10. The belt pulley assembly of claim 9, where each of the plurality of guideposts coaxial and radially interior with respect to the first plurality of springs has an axial proximate end in an associated one of the plurality of first inner cap channels and axially secured to the first inner cap with a threaded fastener.

11. The belt pulley assembly of claim 9, where the plurality of axially extending guideposts have a cylindrical cross section.

12. A belt pulley assembly mounted about a shaft to rotate a belt, the belt pulley assembly comprising:
a segmented guide disk that rotates about the shaft and comprises first and second opposing radial sidewalls and a plurality of axially extending disk holes that includes a linear bearing and extend between the first and second opposing radial sidewalls;
a first end plate section that includes a first inner cap co-axially adjacent to the segmented guide disk and comprising a first end plate section face that includes a plurality of first inner cap channels;
a second end plate section that includes a second inner cap co-axially adjacent to the segmented guide disk and comprising a second end plate section face that includes a plurality of second inner cap channels, where the segmented guide disk axially separates the first and second end plate sections;
a first plurality of springs extending between an associated one of the first inner cap channels and an associated one of the plurality of axially extending disk holes extending into the first opposing radial sidewall;
a second plurality springs extending between an associated one of the plurality of axially extending disk holes extending into the second opposing radial sidewall and an associated one of the plurality of second inner cap channels;
a plurality of axially extending guideposts that each extend into an associated one of the axially extending disk holes and the axial ends of each of the guideposts extend into an associated one of the first and second inner cap channels; and
a plurality of linear bearings located about the guideposts within each of the plurality of axially extending disk holes.

13. The belt pulley assembly of claim 12, where the radius of the segmented disk guide is greater than the radius of the first and second end plate sections.

14. The belt pulley assembly of claim 12, where the first end plate section comprises a first outer cap axially exterior to the first inner cap, and where the second end plate section comprises a second outer cap axially exterior to the second inner cap.

15. The belt assembly of claim 14, further comprising a cam follower attached to radial periphery of the first end plate section axially exterior to the first inner cap to contact the belt when the belt is not tracking in its nominal tracking position over the first segmented guide disk.

16. The belt pulley assembly of claim 15, where the first segmented guide disk is cylindrical and has a disk radius, and the first and second inner caps are cylindrical and have an inner cap radius, where the disk radius greater than the inner cap radius.
